(19) United States
(12) Patent Application Publication
(10) Pub. No.: US 2014/0209707 A1
(43) Pub. Date: Jul. 31, 2014

(54) ELECTRONIC SPRAY CAP

(71) Applicant: MICRO BASE TECHNOLOGY CORPORATION, Bade City (TW)

(72) Inventors: SHU-PING HSIEH, BADE CITY (TW); TUN-YING FANG, BADE CITY (TW); SHAO-MING YANG, BADE CITY (TW); CHIEH-MING HSIUNG, BADE CITY (TW)

(73) Assignee: MICRO BASE TECHNOLOGY CORPORATION, BADE CITY (TW)

(21) Appl. No.: 13/845,105

(22) Filed: Mar. 18, 2013

(30) Foreign Application Priority Data
Jan. 25, 2013 (TW) 102102804

(51) Int. Cl. B05B 11/00

(52) U.S. Cl. CPC B05B 11/3042
USPC 239/338

(57) ABSTRACT

Disclosed is an electronic spray cap installed onto a bottle mouth of a container, and the container contains a solution to be nebulized, and the electronic spray cap includes a cap, a casing, an nebulization module, a power supply and a power extraction module. The cap is applicable to be installed on various different containers; the casing has a liquid storage space and is installed on a side of the cap; the nebulization module and the power extraction module are installed on the casing and interconnected to the liquid storage space; the nebulization module is electrically coupled to the power supply. The power extraction module sucks the liquid to be nebulized into the liquid storage space, and releases, nebulizes and sprays the nebulized liquid out from the nebulization module to improve the convenience of use.

### CROSS-REFERENCE TO RELATED APPLICATIONS

This non-provisional application claims priority under 35 U.S.C. §119(a) on Patent Application No(s). 102102804 filed in Taiwan, R.O.C. on Jan. 25, 2013, the entire contents of which are hereby incorporated by reference.

### BACKGROUND OF THE INVENTION

1. Field of the Invention

The present invention relates to the field of containers with the effect of nebulizing a solution, and more particularly to an electronic spray cap applicable for all containers available in the market and capable of performing an electronic spray of a constant quantity of the nebulized solution.

2. Description of the Related Art

Containers for containing solutions such as perfume, medicine, or cleaning solution to be nebulized are common in the market. To facilitate the use of the container, a nozzle is generally installed at a bottle mouth of the container for sucking the solution to be nebulized from the container and spraying the nebulized solution out from the nozzle for its use.

Most nozzles of this sort come with a rotary screw thread design or a snap-in design for fixing a nozzle at the bottle mouth of the container, and a leak-proof rubber ring is added and installed to provide a good leak-proof effect. The nozzle of this sort adopts the design of a mechanical press button plus a straw, and the press button is pressed to reduce the interior space of the straw to suck and store the liquid to be nebulized into the straw for use. When the press button is pressed again, the liquid to be nebulized is squeezed out from a nozzle hole to achieve the nebulization effect. Since the nebulization effect is not too good, and the quantity of consumption varies with the pressing force or the pressing depth applied to the press button. Even worse, the nebulization sometimes fails at the final stage of the pressing process and gives rise to the problem of leakage.

However, the quantity of consumption of the solution to be nebulized depends on the designed volume of a liquid storage space inside the nozzle which is restricted by the volume of the nozzle and cannot be expanded too much. Therefore, if the quantity of consumption is insufficient, then it will be necessary for the users to press the press button repeatedly. Even worse, the nebulization may fail, and the nozzle of this sort cannot be used for controlling the quantity of consumption of the solution to be nebulized accurately.

At present, there is an electronic nozzle structure available in the market, but it is limited by the principle of nebulization, so that the electronic nozzle structure cannot be installed to a general container as the mechanical nozzle structure does, and the use of the electronic nozzle structure is inconvenient and the scope of its applicability is limited. Therefore, it is an important subject for related manufacturers to overcome the drawbacks of the conventional mechanical nozzle structure and electronic nozzle structure.

### SUMMARY OF THE INVENTION

In view of the problems of the prior art, it is a primary objective of the present invention to provide an electronic spray cap combined with an electronic nebulization module and a mechanical power extraction module in a casing, wherein a cap corresponding to different containers available in the market is installed on a side of the casing and the cap is applicable to be installed at a bottle mouth of different containers, so as to broaden the scope of applicability and improve the convenience of use.

Another objective of the present invention is to provide an electronic spray cap having a liquid storage space with a predetermined volume inside the casing for controlling the quantity of consumption accurately. Further, a viewing window is designed on an external wall of the casing and provided for users to observe the volume of the liquid to be nebulized in the liquid storage space.

To achieve the aforementioned objectives, the present invention provides an electronic spray cap installed onto a bottle mouth of a container, and the container contains a solution to be nebulized. The electronic spray cap comprises: a cap, having a set interface with a diameter falling within a range of 5 mm-50 mm, for sealing the bottle mouth; a casing, installed on a side of the cap and connected to the cap, and the casing having a liquid storage space formed therein, and the liquid storage space having a predetermined volume, and an opening formed on the casing being interconnected to the liquid storage space; an nebulization module, installed at the opening and interconnected to the liquid storage space; a power supply, electrically coupled to the nebulization module, for supplying electric power to drive the nebulization module to operate; and a power extraction module, installed in the casing and penetrated through the cap, and an end of the power extraction module extending to the bottom inside the container; when use, the power extraction module sucks the liquid to be nebulized inside the container into the liquid storage space, and then operates the nebulization module to release, nebulize and spray the liquid to be nebulized in the liquid storage space.

In a preferred embodiment, the electronic spray cap of the present invention further comprises a containing space defined in the casing and disposed at a position with a gap from the liquid storage space, and the power supply is disposed in the containing space, and a first switch is installed on a surface of the casing. The power supply comes with a swappable design and has an insert part, and the containing space has an insert hole corresponding to the insert part, and the insert hole is electrically coupled to the first switch and the nebulization module. In another preferred embodiment, the power supply is installed on an external side of the container and electrically coupled to the nebulization module through an appropriate circuit layout.

In a preferred embodiment, the electronic spray cap of the present invention further comprises a viewing window formed on a surface of the casing, connected to the liquid storage space, and provided for a user to observe the volume of the liquid to be nebulized in the liquid storage space, so that the user can control the quantity of consumption of the solution to be nebulized more easily. Alternatively, the power extraction module has an extraction volume corresponding to the liquid to be nebulized, so that a single operation can suck the required quantity of consumption.

In a preferred embodiment, the electronic spray cap of the present invention further comprises a rotary ring covered around the periphery of the casing, and the rotary ring has an opening corresponding to the nebulization module. After the rotary ring is rotated, the opening can be precisely aligned or misaligned with the nebulization module to serve as a first safety switch to prevent the liquid to be nebulized from being released, nebulized and sprayed. In addition, the rotary ring includes an actuating part disposed on inner side of the rotary ring, and the nebulization module has a first switch, and the actuating part is installed at a position corresponding to the first switch. After turning, the first switch is turned on or off. Such arrangement can serves as the first safety switch for the operation.

In addition, the power extraction module comprises a main body, a press portion, an elastic element, a stopper ball and a straw, wherein the main body is installed in the penetrating hole of the casing and passed through the penetrating hole of the cap, and the main body has a flow outlet corresponding to the liquid storage space, and the electric pump is installed in the main body and connected to the straw, and the second switch is electrically coupled to the power supply and the electric pump, and the bottom end of the straw is extended to the bottom inside the container.

In another preferred embodiment, the cap is integrally formed on a side of the casing to improve the convenience of use and lower the manufacturing cost effectively.

It is noteworthy that the power extraction module of the electronic spray cap of the present invention comes with a fully automatic electric pump design and comprises a main body, an electric pump, the second switch and a straw. The main body is installed in the penetrating hole of the casing and passed through the penetrating hole of the cap, and the main body has a flow outlet corresponding to the liquid storage space. The electric pump is installed in the main body and connected to the straw, and the second switch is electrically coupled to the power supply and the electric pump, and the bottom end of the straw is extended to the bottom inside the container. Alternatively, the power extraction module comes with a semi-automatic pressing design and comprises a main body, a press portion, an elastic element, a stopper ball and a straw. The main body is installed in the penetrating hole of the casing and passed through the penetrating hole of the cap, and the main body has a flow outlet corresponding to the liquid storage space. The press portion is movably installed at the top of the main body, and the elastic element and the stopper ball are covered onto the top of the straw and disposed between the main body and the straw, and the bottom end of the straw is extended to the bottom inside the container. Both designs of the aforementioned power extraction modules can improve the convenience of operation.

### BRIEF DESCRIPTION OF THE DRAWINGS

FIG. 1 is an exploded view of a preferred embodiment of the present invention;

FIG. 2 is a perspective view of a preferred embodiment of the present invention;

FIG. 3 is a first schematic view of an application of a preferred embodiment of the present invention;

FIG. 4 is a second schematic view of an application of a preferred embodiment of the present invention;

FIG. 5 is a schematic view of a first implementation mode of a preferred embodiment of the present invention;

FIG. 6 is a schematic view of a second implementation mode of a preferred embodiment of the present invention;

FIG. 7 is a schematic view of a third implementation mode of a preferred embodiment of the present invention; and

FIG. 8 is a schematic view of a fourth implementation mode of a preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

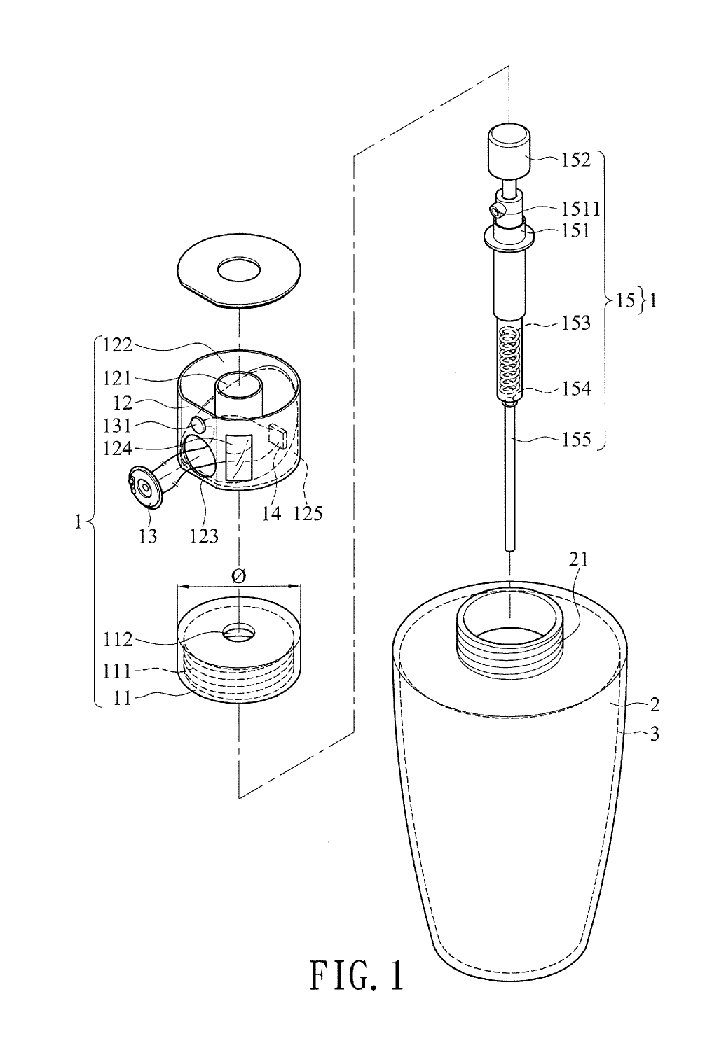

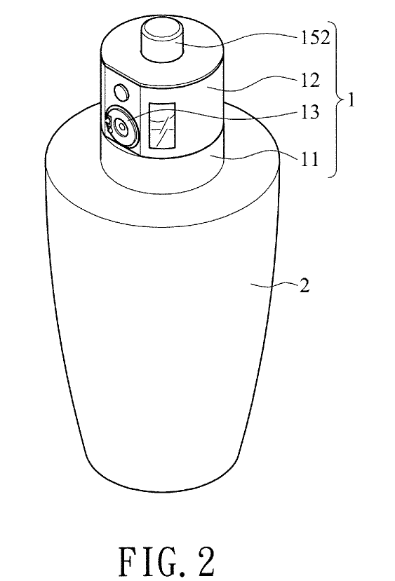

With reference to FIGS. 1 and 2 for an exploded view and a perspective view of an electronic spray cap in accordance with a preferred embodiment of the present invention respectively, the electronic spray cap 1 is installed at a bottle mouth 21 of a container 2, and the container 2 contains a solution to be nebulized 3, and the electronic spray cap 1 comprises a cap 11, a casing 12, an nebulization module 13, a power supply 14 and a power extraction module 15, wherein the power extraction module 15 has a semi-automatic pressing design.

The cap 11 is manufactured with a shape corresponding to the shape of the bottle mouth 21. For a general screw thread type container 2, the cap 11 has a set interface 111 with a diameter from 5 mm to 50 mm and being turned to seal the bottle mouth 21. In addition, the cap 11 has a penetrating hole 112 formed at the center of the cap 11. It is noteworthy that the set interface 111 is not limited to the screw thread type only, but it also can be of a snap-in type or a fixation type applied for covering the cap 11 tightly onto the bottle mouth 21.

The casing 12 is installed at the top of the cap 11 and has a penetrating hole 121 formed at the center of the casing 12 and corresponding to the penetrating hole 112, such that the penetrating hole 121 and the penetrating hole 112 can be aligned precisely with each other for an interconnection. In addition, the casing 12 has a liquid storage space 122 with a predetermined volume, and an opening 123 is formed on a surface of the casing 12 and interconnected to the liquid storage space 122. To improve the convenience of use, a viewing window 124 is formed on a surface of the casing 12 and interconnected to the liquid storage space 122, so that a user can observe the volume of the liquid to be nebulized 3 in the liquid storage space 122. The casing 12 further has a containing space 125 disposed at a position with a gap from the liquid storage space 122.

The nebulization module 13 is installed in the opening 123, and the nebulization module 13 has a first switch 131 which is disposed on a surface of the casing 12 in this preferred embodiment.

The power supply 14 is installed in the containing space 125 and electrically coupled to the first switch 131 and the nebulization module 13. After the first switch 131 is switched, electric power is supplied to drive the nebulization module 13 to operate.

The power extraction module 15 comprises a main body 151, a press portion 152, an elastic element 153, a stopper ball 154 and a straw 155. The main body 151 is installed in the penetrating hole 121 of the casing 12 and passed through the penetrating hole 112 of the cap 11. The press portion 152 is movably installed at the top of the main body 152. The elastic element 153 and the stopper ball 154 are covered onto the top of the straw 155 and disposed between the main body 151 and the straw 155. The bottom end of the straw 155 is extended to the bottom inside the container 2. The main body 151 further has a flow outlet 1511 formed in the liquid storage space 122, and the main body 151 has an extraction volume for sucking the liquid to be nebulized 3 with a volume equal to the extraction volume in one operation.

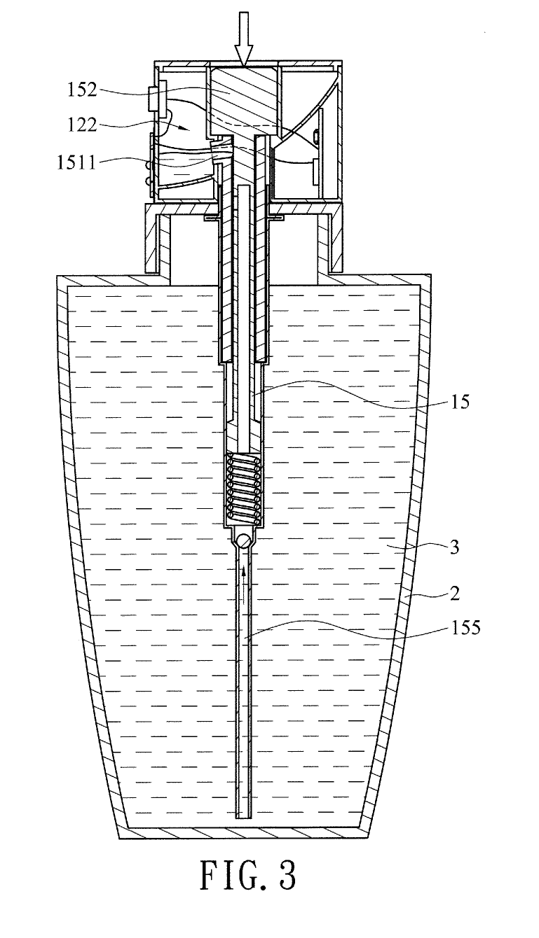

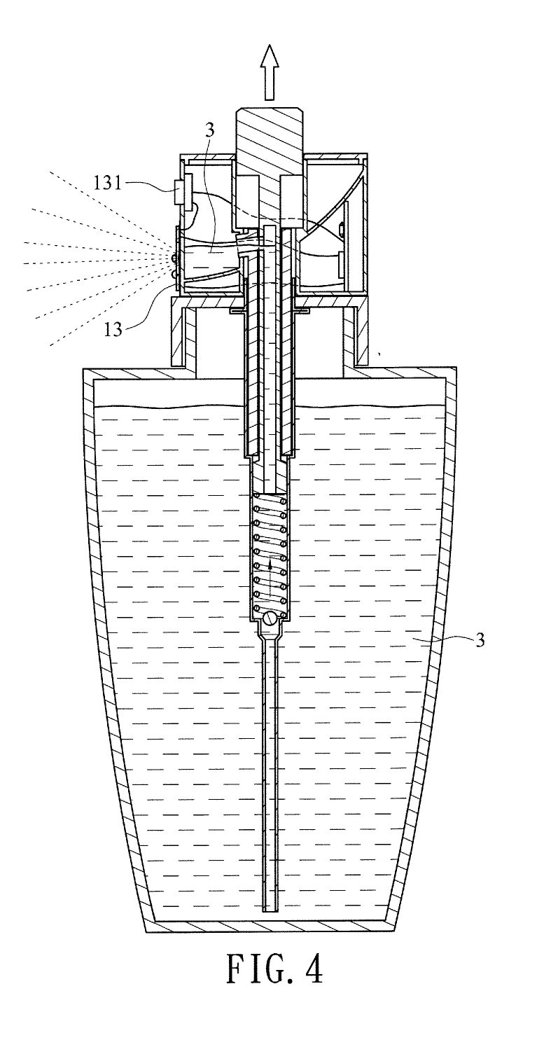

With reference to FIGS. 3 and 4 for schematic views of different applications of a preferred embodiment of the present invention respectively together with FIGS. 1 and 2, the press portion 152 of the power extraction module 15 is pressed to suck the liquid to be nebulized 3 in the container 2 into the straw 155, and the liquid to be nebulized 3 flows from the flow outlet 1511 into the liquid storage space 122, and then the first switch 131 is operated to drive the nebulization module 13 to release, nebulize and spray the liquid to be nebulized 3 contained in the liquid storage space 122.

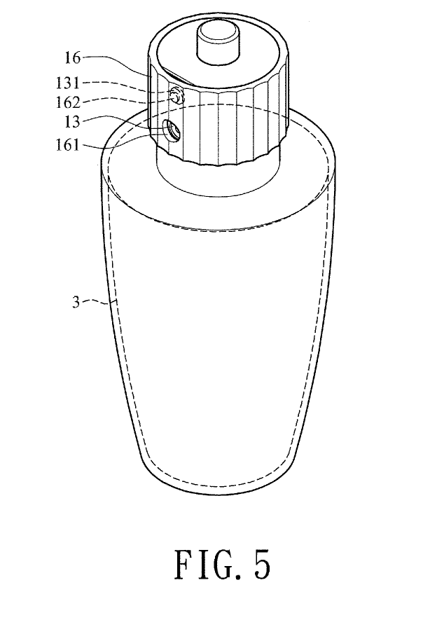

With reference to FIG. 5 for a schematic view of the first implementation mode of a preferred embodiment of the present invention, the electronic spray cap 1 further comprises a rotary ring 16 covered around the periphery of the casing 12, and the rotary ring 16 has an aperture 161 corresponding to the nebulization module 13. After turning, the aperture 161 can be aligned or misaligned with the nebulization module 13 to achieve the effect of disconnect the nebulization module 13 with the outside. In addition, the rotary ring 16 has an actuating part 162 disposed on an inner side of the rotary ring 16 and connected to the first switch 131. After turning, the first switch 131 can be switched on or off, and its double safety design can effectively prevent users from releasing, nebulizing and spraying the liquid to be nebulized 3 by mistake.

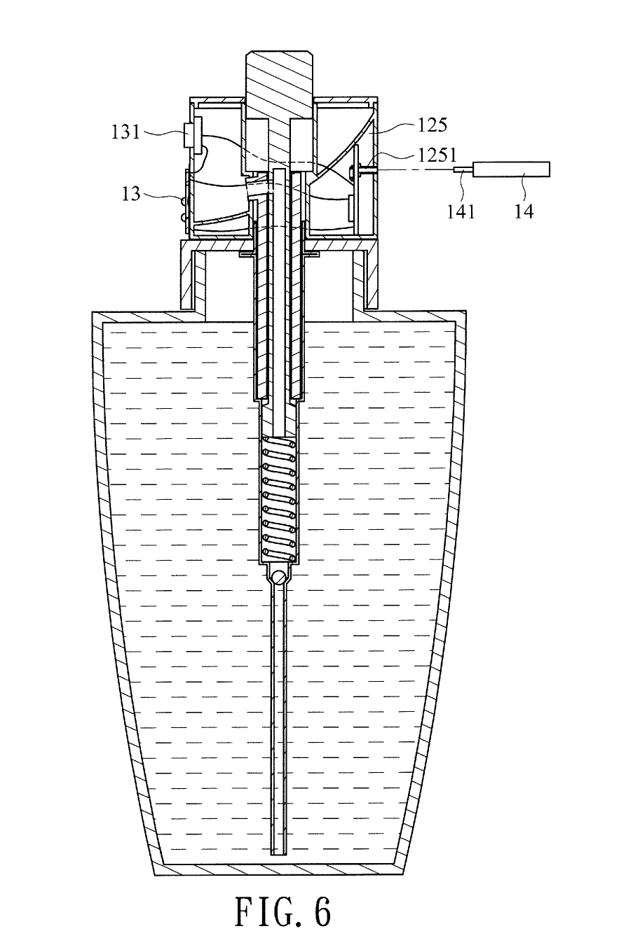

With reference to FIG. 6 for a schematic view of the second implementation mode of a preferred embodiment of the present invention, the power supply 14 comes with a swappable design and has an insert part 141, and the containing space 125 has an insert hole 1251 formed therein and corresponding to the insert part 141, and the insert hole 1251 is electrically coupled to the first switch 131 and the nebulization module 13, and the power supply 14 is in form of a USB flash drive having a thin a mercury battery or a chargeable battery installed therein, and the insert part 141 is in form of a USB device, and the insert hole 1251 is in form of a USB slot. During use, the power supply 14 is plugged into the insert hole 1251 to obtain electric power. After use, the power supply 14 can be removed and placed into the USB slot of a computer for charging.

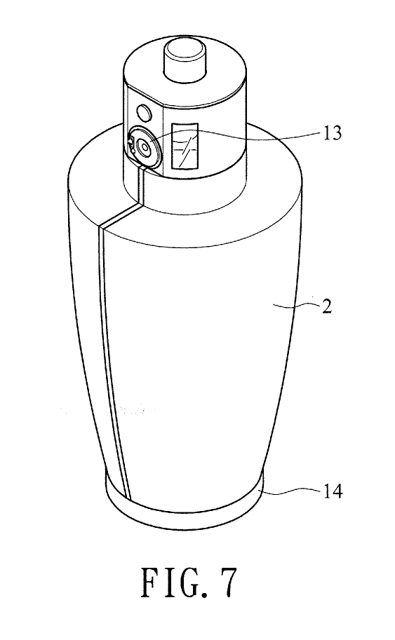

With reference to FIG. 7 for a schematic view of the third implementation mode of a preferred embodiment of the present invention, the power supply 14 is pre-installed at the bottom or external wall of the container 2, and an appropriate circuit is installed on an external wall of the container 2 and electrically coupled to the nebulization module 13, and the operation of the remaining components are the same as those as described in the previous preferred embodiment.

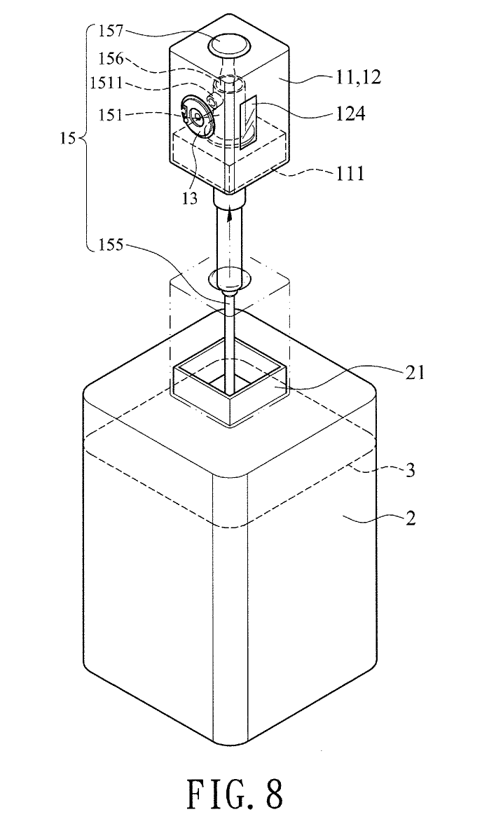

With reference to FIG. 8 for a schematic view of the fourth implementation mode of a preferred embodiment of the present invention, the cap 11 of the present invention is integrally formed at the bottom of the casing 12, and the set interface φ of the cap 11 is in a square shape. The set interface φ of the invention is not limited to such shape only, but it can also be in a three-dimensional polygonal or any other irregular geometric shape. In addition, the bottle mouth of the container 2 is also in a square shape and can be fixed by snap-in or fixation, and the surface of the casing 12 also has the nebulization module 13 and viewing window 124. It is noteworthy that the power extraction module 15 of this preferred embodiment adopts a fully automatic electric pump design and comprises the main body 151, an electric pump 156, the second switch 157 and the straw 155, wherein the main body 151 is also installed in the casing 12 and the straw 155 passed out from the bottom and extended into the container 2, and the electric pump 156 is installed in the main body 151 and connected to the straw 155, and the second switch 157 is electrically coupled to the power supply 14 (not shown in the figure) and the electric pump 156, so that the second switch 157 can be operated to drive the electric pump 156 to be turned on to produce a suction force for extracting the liquid to be nebulized 3 inside the container 2 into the main body 151, and the liquid to be nebulized flows into the casing 12 through the flow outlet 1511.

What is claimed is:

1. An electronic spray cap, installed onto a bottle mouth of a container, and the container containing a solution to be nebulized, and the electronic spray cap comprising:
a cap, having a set interface with a diameter falling within a range of 5 mm˜50 mm, for sealing the bottle mouth;
a casing, installed on a side of the cap and connected to the cap, and the casing having a liquid storage space formed therein, and the liquid storage space having a predetermined volume, and an opening formed on the casing being interconnected to the liquid storage space;
an nebulization module, installed at the opening and interconnected to the liquid storage space;
a power supply, electrically coupled to the nebulization module, for supplying electric power to drive the nebulization module to operate; and
a power extraction module, installed in the casing and penetrated through the cap, and an end of the power extraction module extending to the bottom inside the container; when use, the power extraction module sucks the liquid to be nebulized inside the container into the liquid storage space, and then operates the nebulization module to release, nebulize and spray the liquid to be nebulized in the liquid storage space.

2. The electronic spray cap of claim 1, further comprising a containing space defined in the casing and spaced from the liquid storage space.

3. The electronic spray cap of claim 2, wherein the power supply is disposed in the containing space, and a first switch is installed on a surface of the casing.

4. The electronic spray cap of claim 3, wherein the power supply comes with a swappable design and has an insert part, and the containing space has an insert hole corresponding to the insert part, and the insert hole is electrically coupled to the nebulization module.

5. The electronic spray cap of claim 4, further comprising a viewing window formed on a surface of the casing, connected to the liquid storage space, and provided for observing the volume of the liquid to be nebulized in the liquid storage space.

6. The electronic spray cap of claim 5, further comprising a rotary ring covering around the periphery of the casing, and the rotary ring has an opening corresponding to the nebulization module, and after the rotary ring is rotated, the opening is precisely aligned or misaligned with the nebulization module.

7. The electronic spray cap of claim 6, wherein the rotary ring includes an actuating part disposed on inner side of the rotary ring, and the nebulization module has a first switch, and the actuating part is installed at a position corresponding to the first switch and after the actuating part is rotated, the first switch is turned on or off.

8. The electronic spray cap of claim 7, wherein the power supply is disposed external to the container.

9. The electronic spray cap of claim 8, wherein the power extraction module comes with a fully automatic electric pump design and comprises a main body, an electric pump, the second switch and a straw, and the main body is installed in the penetrating hole of the casing and passed through the penetrating hole of the cap, and the main body has a flow outlet corresponding to the liquid storage space, and the electric pump is installed in the main body and connected to the straw, and the second switch is electrically coupled to the power supply and the electric pump, and the bottom end of the straw is extended to the bottom inside the container.

10. The electronic spray cap of claim 1, wherein the power extraction module comes with a semi-automatic pressing design, and comprises a main body, a press portion, an elastic element, a stopper ball and a straw, and the main body is installed in the penetrating hole of the casing and passed through the penetrating hole of the cap, and the main body has a flow outlet corresponding to the liquid storage space, and the press portion is movably installed at the top of the main body, and the elastic element and the stopper ball are covered onto the top of the straw and disposed between the main body and the straw, and the bottom end of the straw is extended to the bottom inside the container.

11. The electronic spray cap of claim 1, wherein the cap is integrally formed on a side of the casing.
